(19) United States
(12) Patent Application Publication
(10) Pub. No.: US 2006/0178130 A1
(43) Pub. Date: Aug. 10, 2006

(54) Method for payment in association with IP multimedia sessions in a communication network

(75) Inventor: Sotiris Makrygiannis, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/085,058

(22) Filed: Mar. 22, 2005

(30) Foreign Application Priority Data
Feb. 7, 2005 (FI) 20050140

(51) Int. Cl. H04M 11/00

(52) U.S. Cl. 455/406; 455/405

(57) ABSTRACT

The invention relates to a method for payment in association with a group session in a communication system comprising at least a mobile station, a session control node and an application server. In the method the user in the mobile station selects a group session identifier. A session set-up request comprising the group session identifier is sent from the mobile station to the application server. The mobile station is engaged in the application server in a group session associated with the group session identifier. To the group session belongs at least one other communication device. A payment request message is sent from the communication device to the mobile station. The payment request message is accepted in the mobile station and a payment accept message is sent to the communication device via the session control node and the application server. The session control node submits a charging record to a billing center, the charging record comprising information from the payment accept message.

### BACKGROUND OF THE INVENTION

1. Field of the Invention

The invention relates to payment transactions in a communication network. Particularly, the invention relates to a method for payment in association with Internet Protocol (IP) multimedia sessions in a communication network.

2. Description of the Related Art

IP multimedia is an emerging field in communications. IP multimedia enables voice, video and application data to be communicated in interrelated fashion over a communication network such as the Internet. In IP multimedia the calls that combine one or more media streams or connections such as voice, video and application data exchange are referred to as sessions. IP multimedia sessions are established over IP networks using, for example, the Session Initiation Protocol (SIP), which is specified by the Internet Engineering Task Force (IETF) in the documents RFC 3261 and RFC 2543, or the H.323 protocol, which has been specified by the International Telecommunication Union (ITU-T).

IP multimedia is also emerging in cellular communication networks. The 3G Partnership Project (3GPP) has specified a number of standards the purpose of which is to provide for IP multimedia sessions in 3G networks. The IP Multimedia Subsystem (IMS) in the Core Network (CN) side is specified in the 3GPP specification 23.228. The radio interface support for IP multimedia sessions rely, for example, on the Quality of Service (QoS) functionalities specified in the 3GPP requirements document 23.907. The Internet Protocol (IP) data transfer is based on the packet switched CN infrastructure specified in the 3GPP specification 23.002.

One of the most important services that are to be provided by means of the 3G IP Multimedia Sub-system is the Push-To-Talk (PTT) over cellular service, which is referred to using the acronym PoC. In PoC the cellular mobile terminals are used to emulate a walkie-talkie radiotelephone. In PoC mobile terminals may establish multiparty sessions between one another. In the multiparty sessions the floor is given to only one terminal at a time. The information sent by an active terminal is transmitted to all the other terminals participating in the multiparty session. The PoC service supports the transmission of not only voice but video, still picture or application data as well. Thus, it is possible for the active terminal to send also visual data. The Open Mobile Alliance (OMA) specifies the PoC service. The PoC service is disclosed, for example, in the article “Performance Estimation of a SIP based Push-to-Talk Service for 3G Networks”, Eoin O'Regan and Dirk Pesch, Adaptive Wireless Systems Group, Cork Institute of Technology, Ireland.

Reference is now made to FIG. 1, which illustrates an IP Multimedia Subsystem in prior art. In FIG. 1 there is a mobile station 100, which is a mobile terminal, for example, a UMTS 3G mobile terminal. A mobile station 100 is communicating with a UMTS radio access network UTRAN 102. UTRAN 102 takes care of all radio related tasks such as reservation of radio channels and a quality of service for IP multimedia sessions. UTRAN 102 is connected to a packet switched core network 104. Packet switched core network 104 comprises a number of General Packet Radio Support Nodes (GSN) such as Gateway GPRS Support Nodes (GGSN) and Serving GPRS Support Nodes (SGSN). These support nodes take care of relaying IP packet between the UTRAN and a Media Gateway 122. Packet switched core network 104 is connected to a proxy call state control function P-CSCF 106. Proxy P-CSCF 106 is a Session Initiation Protocol (SIP) proxy, which relays SIP signalling between PS CN 104 and Inquiring CSCF 108. Inquiring CSCF 108 communicates with a Serving CSCF (SCSCF) 110. Inquiring CSCF determines the Serving CSCF that currently serves a mobile station 100. IP Multimedia Subsystem also comprises a Home Subscriber Server (HSS) 112, which comprises all subscriber related data, that is, records on subscriptions served by the IP Multimedia Subsystem. IP Multimedia Subsystem also comprises a Media Gateway Control Function (MGCF) 120, which manages media streams in media gateway 122. Media gateway 122 is connected to Public Switched Telephone Network (PSTN) 124. The billing data on IP multimedia sessions is gathered in a billing centre 116. Serving CSCF submits charging records to billing centre 116 using, for example, the IETF diameter protocol. Push-to-Talk over Cellular (PoC) service is provided for by application server 114. Application Server (AS) 114 is connected to packet switched core network 104, which provides the user plane IP packets to application server 114. Application server 114 receives SIP signalling messages from serving CSCF 110. Application server 114 is responsible for setting up these multiparty Push-to-Talk over cellular sessions. Application server 114 copies the user plane data packages received from an originating terminal and sends this data package to a number of receiving terminals. The terminal that is sending the IP packets is the one that has currently floor. Application server 114 receives a SIP invite message, which is referring to a group session URI. This invite message comprises a Uniform Resource Identifier (URI), which specifies a number of SIP URIs that belong to all the parties that are desired to be invited to a group session, in other words, a group call with option for multimedia use. Signalling is illustrated in FIG. 1 using a dashed line and user plane traffic using a solid line.

Reference is now made to FIG. 2, which illustrates Push-to-Talk over cellular group session set-up and release in prior art. In FIG. 2 there is a Mobile Station for the calling subscriber (MS-A) 100 and a serving CSCF 110. There is also application server 114 and serving CSCF 250. Mobile station for the called party is a Mobile Station (MS-B) 252. At time t₁ the mobile station 100 desires to set-up a SIP group session towards a number of different session participants. The set of other parties in the group session are predefined and are referred to using a group session URI. A group session URI is also referred to as a factory URI. The factory URI is used by application server 114 to obtain the list of SIP URIs that are to be invited to the group session as it is established. The receiving of a SIP Invite message to the factory URI indicates to application server 114 that the group session must be established, if it does not exist already.

At time t₁ mobile station 100 sends an SIP Invite message to serving CSCF 110. The SIP Invite message comprises a factory-URI. As illustrated with arrow 201, MS 100 sends a SIP invite message to serving CSCF 110. Upon receiving a SIP Invite message serving CSCF 110 sends a SIP 100 Trying response message to mobile station 100 as illustrated with arrow 202. Serving CSCF 110 sends a SIP Invite message to application server 114 as illustrated with arrow 203. Upon receiving a SIP invite message application server 114 sends a SIP 100 Trying response message to serving CSCF 110 as illustrated with arrow 204. Due to the fact that a group session does not exist, application server 114 takes the factory-URI and resolves the factory-URI to a number of URI-Bs that refer to all the other parties that are to be invited to this group session. Arrow 205 illustrates the invitation of a first called party that is invited to the group session. SIP invite message comprising URI-B is sent from application server 114 to serving CSCF 250. Serving CSCF 250 is the serving CSCF that is currently serving the called party, that is, the mobile station 252. As illustrated with arrow 206 serving CSCF 250 sends a SIP 100 Trying message to the application server 114. As illustrated with arrow 207 serving CSCF 250 sends a SIP Invite message to mobile station B 252. As illustrated with arrow 208, mobile station 252 sends SIP 100 Trying message to serving CSCF 250. As mobile station 252 is reached a SIP 180 Ringing message is sent towards mobile station 100 as illustrated with arrows from 209 to 213. The SIP 180 Ringing message traverses the route serving CSCF 250, application server 214 and serving CSCF 110 and from there is sent to mobile station 100. Upon answering to the group session, mobile station B 252 sends a SIP 200 OK message towards MS-A, as illustrated with arrows from 214 to 217. In response the receiving the SIP 200 OK message mobile station A sends a SIP ACK, that is acknowledgement message, towards mobile station 252. The ACK message is illustrated in FIG. 2 with arrows from 218 to 221. As the ACK message is received by mobile station B 252 the SIP multimedia group sessions is now in active state. In active state any of the call parties may request floor. That is they may request the permission to send IP packets that are to be distributed to all other call parties. As explained before, the IP packets may carry voice, video or application data. When any of the called parties wishes to terminate the SIP group call a SIP BYE message is sent. In FIG. 2 mobile station 252 sends a SIP BYE message towards mobile station 100. The BYE messages are illustrated in FIG. 2 with arrows from 222 to arrow 225. The received BYE message is acknowledged by mobile station A 100 using a SIP 200 OK message, which is sent towards mobile station 252 as illustrated with arrows from 226 to 229. Currently, the billing for the use of Push-to-Talk over cellular service is based on such factors as the duration of the user's participation in a group multimedia session and the duration of talk spurts issued by that user.

By means of the SIP is provided also a presence service, which enables IP multimedia users to be notified of the presence of each other. A user may subscribe to presence status notifications pertaining to a number of other subscribers, which are called buddies. Whenever there is a change in the presence status the subscribing user is notified of the change. The presence status provides information whether the subscribed user has her terminal on, that is, the terminal is registered to the network, whether the subscriber is busy in a session or whether the user is currently defined to be unavailable in her schedule. The presence service is specified in the 3GPP specification 23.141.

An interesting application for the PoC service would be teleshopping. It would be beneficial, if there were a possibility to make an instant payment in association with a multiparty session or, generally, in association with a two-party session. The instant payment would occur after a purchaser is provided with an interesting service offer pertaining, for example, to a product that has earlier been presented to the purchaser during-the multiparty session. For example, a user interested in buying a cake would contact a number of bakeries via a multiparty session. The user would be first given the floor to present the requirements for the cake. Thereupon, the floor would be given to a number of competing bakeries, which would present their cakes, their price information and the delivery options. Finally, a bakery would send a purchase offer, which is accepted by the user and submitted to payment. The problem involved with this kind of services is that currently there exists no mechanism to perform the payment flexibly in association with such a multiparty call. Further, there exists no mechanism that would allow the payment to be made via the billing center of the cellular system so that the payment is included in the users phone bill.

Currently, in circuit switched networks there exists a payment mechanism that allows users to place calls to chargeable service numbers and as the call is put through, a fixed charge charging record associated with the users telephone number is generated and submitted to the billing system. However, in association with multiparty IP multimedia sessions there does not currently exist a mechanism that would allow a second call party to generate a charge to be associated with a purchasing party. The prior art publication WO 02/078362 discloses a mechanism where a service control entity may provide a charging request for a call control entity to be associated with a call party in response to the delivery of a message to that call party. However, the problem associated with the approach in WO 02/078362 is that it relies on a trusted service control entity, which generates the charging request based on its knowledge of the message and its contents.

The Sumit Mobile System Ltd in Shanghai, China provides an alternative system. The Sumit's system works through connecting a cell phone to a bank account. In the system the user may receive payment request messages that are accepted by the user. Upon accepting the messages, the payment sum is debited from the users bank account. The reliability of the system relies on the fact that mobile terminals are authenticated in the mobile network. With the Sumit system, a fraudulent user would have to break into a phone network, and steal user information and to steal the users phone. The Sumit system does not to the knowledge of the applicant support payment in association with IP multimedia sessions so that the mobile network is capable of verifying the association of the payment request with an ongoing IP multimedia session, especially in the case where there are a number of parties potentially issuing payment requests for the user. Further, the Sumit system does not support the utilization of a billing system to which charging records are provided from multimedia session control nodes. Thus, the Sumit system does not support the payment of goods and services via phone bills.

### SUMMARY OF THE INVENTION

The invention relates to a method for payment in association with a group session in a communication system comprising at least a first mobile station, a session control node and an application server, the method comprising: selecting a group session identifier in the first mobile station; sending a session set-up request comprising the group session identifier from the first mobile station to the application server; engaging in the application server the first mobile station in a group session associated with the group session identifier, the group session further comprising at least a second station; sending a payment request message from the second station to the first mobile station; accepting the payment request message in the first mobile station; sending a payment accept message from the first mobile station to the second station via the session control node and the application server; and submitting a charging record from the session control node to a billing center, the charging record comprising information from the payment accept message.

The invention relates also to a communication system comprising at least a first mobile station, a session control node and an application server, the system further comprising: a communication entity in the first mobile station configured to select a group session identifier in the first mobile station, to send a session set-up request comprising the group session identifier from the first mobile station to the application server; a group session entity in the application server configured to engage the first mobile station in a group session associated with the group session identifier, the group session further comprising at least a second station; a service supplier entity in the second station configured to send a payment request message to the first mobile station; a service purchase entity in the first mobile station configured to accepting the payment request message in the first mobile station, to send a payment accept message to the second station via the session control node and the application server; and a charging entity in the session control node configured to submit a charging record to a billing center, the charging record comprising information from the payment accept message.

The invention relates also to an electronic device comprising: a communication entity configured to select a group session identifier, to send a session set-up request comprising the group session identifier to an application server; and a service purchase entity configured to accept a payment request message, to send a payment accept message to a second station via a session control node and the application server.

The invention relates also to an application server comprising: a group session entity configured to receive a session set-up request comprising a group session identifier from a first mobile station, to engage the first mobile station in a group session associated with the group session identifier, the group session further comprising at least a second station, to relay a payment request message and a payment accept message between the first mobile station and the second station, to check the validity of the payment accept message, the validity comprising at least the existence of the group session between the first mobile station and the second station, and to submit a payment data message comprising information from the payment accept message to a session control node.

The invention relates also to a computer program comprising code adapted to perform the following steps when executed on a data-processing system: receiving a session set-up request comprising a group session identifier from a first mobile station; engaging the first mobile station in a group session associated with the group session identifier, the group session further comprising at least a second station; receiving a payment request message from the second station; sending the payment request message to the first mobile station; receiving a payment accept message from the first mobile station; informing the second station of the payment accept message; and submitting a payment data message comprising information from the payment accept message to a session control node.

In one embodiment of the invention, to the group session are connected the first mobile station and the second station. The first mobile station represents a service purchaser party. The second station represents a service supplier party. In one embodiment of the invention, there is at least one another station for at least one another service supplier party. In one embodiment of the invention, to the group session may also be connected at least one other service purchaser party, which may use a fixed station or a mobile station.

In one embodiment of the invention, the group session, in other words, the group multimedia session is a voice call. In one embodiment of the invention, the group session, in other words, the group multimedia session is a voice and video session, which may also comprise the exchange of still pictures, application protocol data, documents and other media.

In one embodiment of the invention, the group session is a mere two-party session between the first mobile station and a second station. In one embodiment of the invention the group session is a multiparty session between the first mobile station and a number of second stations. The number of second stations is at least one. In one embodiment of the invention, the number of second stations participating to the group session with the first mobile station may vary during the course of the session. Similarly, during the lifetime of the group session there may be points in time where the first mobile station is not connected to the group session and to the session is merely connected a number of second stations. Thus, in this embodiment of the invention, at different points in time the session may be either a two-party session, a multiparty session or a single-party session. It should be noted that the invention supports both two-party sessions and group sessions.

In one embodiment of the invention, the group session is a conference session, wherein the session parties may transmit media information simultaneously and are connected to a conference bridge, which combines the media streams from each party to a single media stream that is transmitted to each party.

In one embodiment of the invention, the group session is a Push-To-Talk over Cellular (PoC) session.

In one embodiment of the invention, the first mobile station subscribes to event notifications associated with the group session identifier. In response to the subscription, the first mobile station receives at least one notification associated with the group session identifier from the application server. The notifications are sent based on the presence status of the second station and other possible stations acting as service supplier stations.

The first mobile station updates the status of the group session identifier based on the at least one notification. The status information may be presented on the display of the mobile station. The first mobile station checks the status in response to detecting a session set-up command associated with the group session identifier from the user and accepts or rejects the session set-up command based on the status. The command is issued by the user in the forms of, for example, the pressing of a function key, the selection of a user interface option or a voice command.

In one embodiment of the invention, the validity of the payment accept message is checked in the application server by the group session entity. The validity comprises at least the existence of the group session between the first mobile station and the second station. The group session entity submits a payment data message from the application server to the session control node, if the payment accept message proves to be valid. The session control node generates the charging record in the charging entity based on information in the payment data message.

In one embodiment of the invention, the purchase entity or a security entity in the first mobile station forms a digital signature for the payment accept message using a secret key associated with the first mobile station. The validity of the digital signature is checked in the billing center. The billing center may obtain a public key certificate for the first mobile station and from it extract the public key associated with the first mobile station.

In one embodiment of the invention, the service supplier party provides from the second station a digital content for downloading to the first mobile station. Thus, the invention may also be related to the payment of content downloading services. In one embodiment of the invention, the payment is associated with services provided outside of the electronic realm such as deliverable goods.

In one embodiment of the invention, the first mobile station is a General Packet Radio System terminal or a Universal Mobile Telecommunications System terminal.

In one embodiment of the invention, the first mobile station is a Wireless Local Area Network (WLAN) mobile station. The WLAN may be connected to the IP Multimedia Subsystem (IMS).

In one embodiment of the invention, the group session comprises a Push-to-Talk over Cellular (PoC) group session and the application server comprises a Push-to-Talk over Cellular (PoC) server.

In one embodiment of the invention, the session control node comprises a Call State Control Function (CSCF). In one embodiment of the invention, the session control node comprises a Mobile Switching Center (MSC). In one embodiment of the invention, the session control node comprises a Mobile Switching Center (MSC) server.

In one embodiment of the invention, the application server is configured to exchange Session Initiation Protocol (SIP) signaling with at least one session control node in order to establish group multimedia sessions. The application server may be considered as an IP Multimedia Subsystem (IMS) application server.

In one embodiment of the invention, the messages for accepting of payment and requesting of payment comprise Session Initiation Protocol (SIP) messages.

In one embodiment of the invention, the session comprises an IP multimedia session. The second station may be, for example, a fixed or a mobile terminal, with which sessions are established using Session Initiation Protocol (SIP) signaling.

In one embodiment of the invention, the electronic device comprises a mobile station. The electronic device may also be a mobile terminal, to which a Subscriber Identity Module (SIM) may be attached. In one embodiment of the invention, the electronic device comprises, for example, a SYMBIAN™ operating system device.

In one embodiment of the invention, the computer program is stored on a computer readable medium. The computer readable medium may be a removable memory card, magnetic disk, optical disk or magnetic tape.

In one embodiment of the invention, the electronic device is a mobile device, for example, a laptop computer, a palmtop computer, a mobile terminal or a personal digital assistant (PDA) . In one embodiment of the invention, the electronic device is a desktop computer or a mainframe computer.

In one embodiment of the invention, the second station is a mobile device, for example, a laptop computer, a palmtop computer, a mobile terminal or a personal digital assistant (PDA). In one embodiment of the invention, the second station is a desktop computer or a mainframe computer. The second station may also be a fixed communication network terminal device, such as, for example, a SIP phone.

The benefits of the invention are related to the improved flexibility in the purchasing of services. The invention enables products or services to be purchased during the course of a group multimedia session. The purchase may be added to the purchaser's normal phone bill in a manner similar to the use of communication services such as calls.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an IP Multimedia Subsystem in prior art;

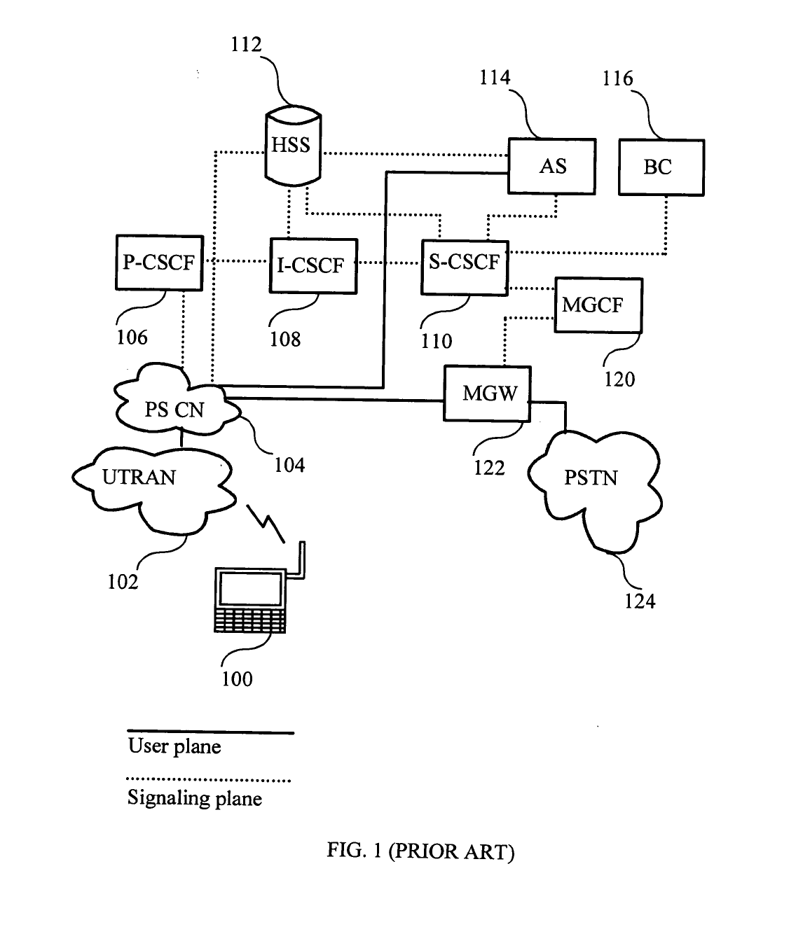

FIG. 2 is a message sequence chart illustrating Push-to-Talk over Cellular (PoC) group session set-up and release in prior art;

FIG. 3 is a message sequence chart, which illustrates a method for payments in association with SIP multimedia sessions in one embodiment of the invention;

FIG. 4 is a flow chart illustrating one embodiment of a method for payment in association with multiparty sessions

FIG. 5 is a block diagram illustrating a communication network in one embodiment of the invention; and

FIG. 6 is a block diagram illustrating a mobile station and the associated user interface in one embodiment of the invention.

### DETAILED DESCRIPTION OF THE EMBODIMENTS

Reference will now be made in detail to the embodiments of the present invention, examples of which are illustrated in the accompanying drawings.

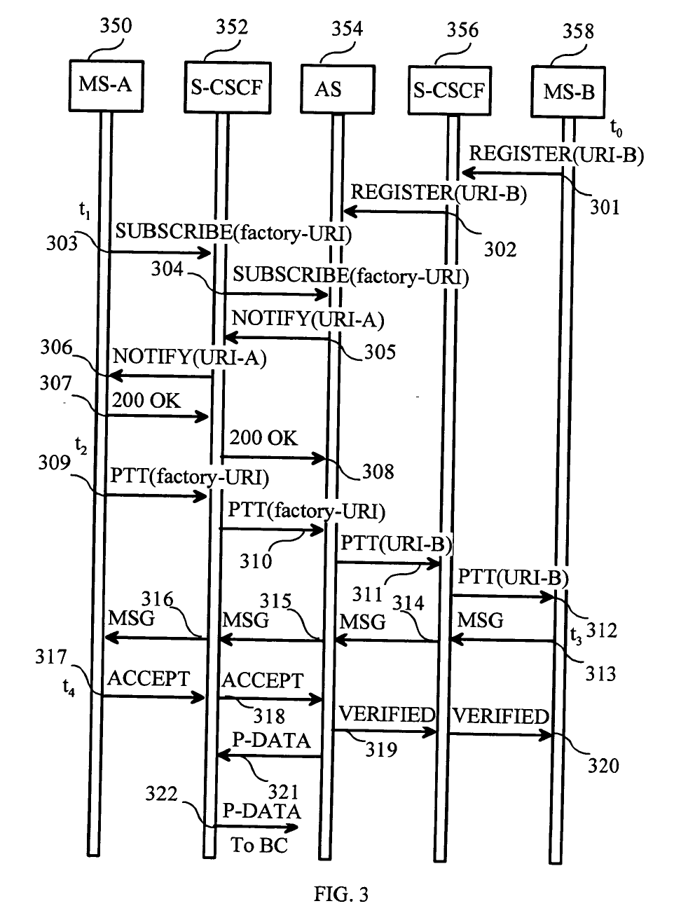

FIG. 3 is a message sequence chart, which illustrates a method for payments in association with SIP multimedia sessions in one embodiment of the invention. In FIG. 3 there is mobile station 350, used by the establisher of the group session, a serving CSCF 352, an application server 354 and a serving CSCF 356 and a mobile station 358. Mobile station represents a subscriber that is providing some service that may be purchased by the user of mobile station 350 during the course of the group session.

At time to a mobile station 358 is powered on. In response thereto, mobile station 358 sends a SIP Registration message towards a serving CSCF 356 assigned to it. The SIP Registration message is illustrated with arrow 301. The serving CSCF 356 has been informed that mobile station is participating to a permanent SIP group call. The informing of serving CSCF 356 is performed, for example, via subscriber data provided from an HSS. Due to the participation to a permanent SIP group session, serving CSCF 356 forwards SIP Register message towards application server 354, as illustrated with arrow 302.

At time t₁ mobile station 358 is available and accessible through the network. At time t₁ the mobile station 350 subscribes a notification pertaining to the group session. The purpose of the subscription is to establish information on what participants of this permanent group session are reachable and whether the group session already exists. Mobile station 350 sends a SIP Subscribe message to serving CSCF 352, as illustrated with arrow 303. The SIP subscribe message comprises a factory-URI which refers to all the group session parties in addition to mobile station 350. Serving CSCF 352 observes that the SIP Subscribe message comprises a factory-URI that refers to a group call managed by application server 354. Therefore, serving CSCF 352 decides to forward the SIP Subscribe message to application server 354 as illustrated with arrow 304. First application server 354 sends a SIP Notify message towards mobile station 350 concerning the registration status of each of these group session parties. Therefore, relating to mobile station B 358 a notification message is sent towards mobile station A 350. The notification message comprises the status information associated with mobile station B 358. The sending of the notify message is illustrated with arrows 305 and 306. The receipt of notify message is acknowledged by mobile station A 350 using SIP message 200 OK which is sent towards application server 354 for sending a SIP 200 OK message as illustrated with arrows 307 and 308.

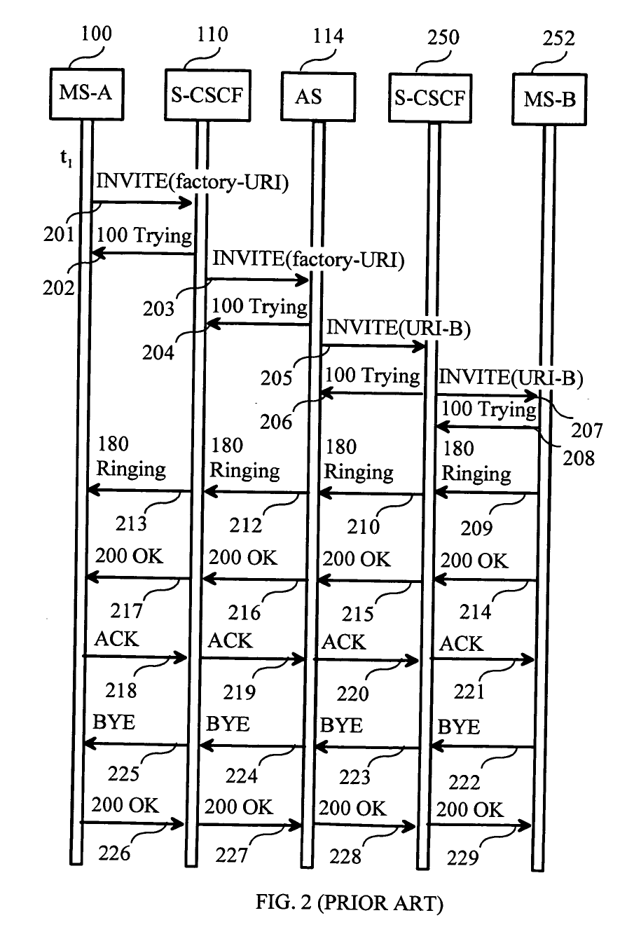

At time t₂ mobile station A 350 desires to set up a group multimedia session. A Push-to-Talk request message is sent to serving CSCF 352 as illustrated with arrow 309. In one embodiment of the invention the Push-to-Talk request message is a SIP Invite message. The Push-to-Talk request message comprises a factory-URI. Upon detecting the factory-URI serving CSCF 352 determines that the Push-to-Talk request message is to be sent to application server 354. The Push-to-Talk request message is illustrated with arrow 310 as it is sent to application server 354. Application server 354 determines on the basis of the factory-URI the list of all the called parties to which this SIP multimedia group session is to be established. The list comprises at least one URI. One such URI is the URI-B as illustrated in FIG. 3. There may be a number of other similar URIs. A Push-to-Talk request message is sent from application server 354 to all the called parties. The first sending of Push-to-Talk request message towards mobile station B 358 is illustrated with arrow 311 and 312. A similar Push-to-Talk request message may be sent to any number of other SIP multimedia group session participants. Mobile station 358 is just one example of such a multimedia session party. It should be noted that the other messages required for the setting up of the group session are not shown in FIG. 3. The Push-To-Talk request message may be followed by a number of response messages sent from mobile station 358 and application server 354 backwards in the direction of mobile station 350. These response messages are not shown in FIG. 3. In one embodiment of the invention, the SIP signalling pertaining to the invitation of a number of mobile stations to the group session occurs as illustrated in FIG. 2 with arrows from 201 to 221. As the group session is in active state floor may be requested in turn by mobile stations 350 and 358. There may also be other parties (not shown) in the group session.

At time t₃ mobile station 358 decides to send a payment request message towards mobile station 350. The payment request message is illustrated with arrows from 313 to 316. The payment message comprises some identification of the service to be purchased and the price of the service. The payment request message also comprises identification information for mobile station 350 by means of which the payment message is routed to mobile station 350. Before the payment message is sent there may have been number of talk spurts between the group multimedia session participants, a number of information may have been exchanged and various products or service offerings may have been placed using, for example, audio, video and application data. As mobile station 350 receives the payment request message, the user of mobile station 350 decides to accept the payment request. The payment request may be presented in mobile station 350 to its user so that mobile station 350 shows together with the payment request the sender of the request and at least one latest multimedia spurts sent by mobile station 358. This is supported so that mobile station 350 keeps in its memory at least one multimedia spurt that has been received latest. The multimedia spurts to be stored may be specially indicated with a specific indicator sent in association with the spurt. In response to the presenting of the payment request, the user selects an accept option in mobile station 350 user interface. The accept option may be, for example, a key on a keypad, a graphic user interface element or an audio command.

As the user of mobile station 350 accepts the payment at time t₄, an accept message as illustrated with arrows 317 and 318 is sent towards application server 354. The information from the accept message is sent to mobile station 358 in the form of a payment verified message as illustrated with arrows 319 and 320. The message traverses the serving CSCF associated with mobile station 358.

In one embodiment of the invention, upon receiving the accept message 317 from mobile station 350, serving CSCF 352 stores the accept message data comprising at least the identification of mobile station 350 and the payment sum. Application server 354 sends a payment data message to serving CSCF 352 as illustrated with arrow 321. The benefit of circulating the accept message data via application server 354 lies in the fact that it may verify the right of mobile station 358 to originate such payment requests. Further, it is not possible to introduce a malicious software component to mobile station 350, which simply submits arbitrary promiscuous payment messages on behalf of the user. The presence of application server 354 guarantees that the payment accept messages are related to a group session and that payment request messages are originated from a service supplier party in an existing group session to which mobile station 350 belongs. This embodiment of the invention relies on the trust that has been established via the authentication of mobile station 350 to the IMS comprising serving CSCF 352 and the trust existing between service CSCF 352 and application server 354. The latter trust may rely upon the use of firewalls in IMS, the use of a security association between the mentioned network elements or an earlier authentication between the mentioned network elements. Application server 354 may perform a further verification to check that a media spurt has been originated from the service supplier that originates the payment request message. In one embodiment of the invention, the media spurt must have been received within a predefined time limit backwards from the payment request message in order for the payment message to be valid.

The payment message data must specify at least the identification of mobile station 350 and the payment sum. The payment sum may also be expressed in terms of other charging units than currency, for example, charging pulses. Serving CSCF 352 compares the payment data message to the message received from application server 354 to the stored accept message data. If the comparison is successful, serving CSCF 352 forms a call detail record using the payment data message that specifies the payment of the service. The call detail record comprises information and mobile station 350 and the price of the service. The call detail record data is sent as payment data message 322 towards a billing centre (not shown). The billing centre ensures that the payment is included in the phone bill for the user of mobile station 350.

In one embodiment of the invention, it is not necessary to receive payment data from application server 354. In this embodiment, the payment accept message is signed digitally using a secret key associated with mobile station 350. This comprises that a message digest is computed of the payment accept message and the message digest is encrypted using the secret key of the mobile station. The payment accept message may be submitted directly to the billing centre from the serving CSCF. The digital signature may be verified in the billing centre using a public key associated with the mobile station. The public key may in turn be verified using a public key certificate associated with the mobile station.

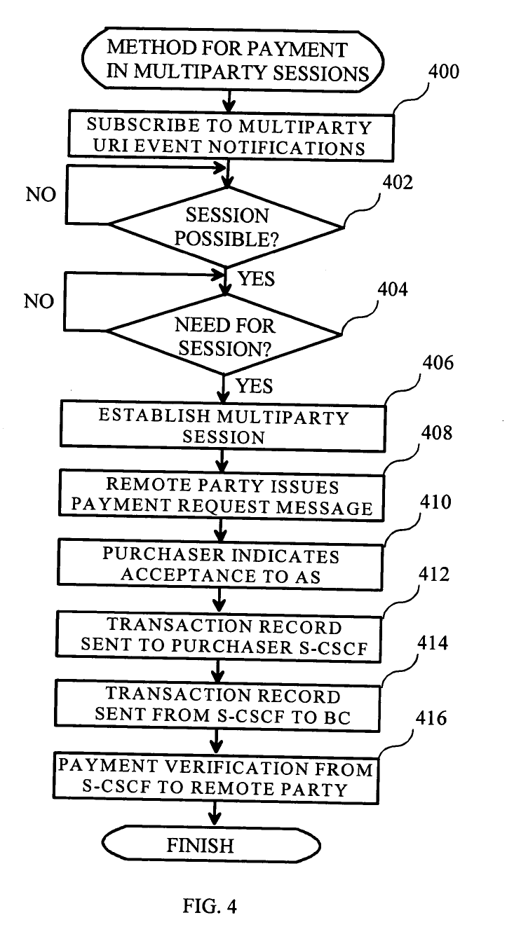

FIG. 4 is a flow chart illustrating one embodiment of a method for payment in association with multiparty sessions. A separation among the group multiparty session parties may be made. In the separation each parties is considered either as a purchaser or service supplier. As the potential purchaser wishes to engage in a group session, she is assigned to either a pre-existing group session or to a group session, which is established based on her request. With the group session is associated at least one service supplier and at least the purchaser herself. Additionally, there may be at least one other purchaser.

In one embodiment of the invention, the purchaser mobile station is, for example, mobile station 350 as illustrated in FIG. 3. Similarly, the service supplier mobile station is, for example, mobile station 358 as illustrated in FIG. 3.

At step 400 a purchaser subscribes to event notifications associated with a given multiparty URI. In one embodiment of the invention, the URI may also be a mere two-party session URI. The subscription is performed for all the potential service supplier parties. The service supplier parties are associated with the multiparty URI, which represents the group session, which either exists already or is to be established in step 406. The multiparty URI is also referred to as a factory URI. The term factory URI stems from the fact that it is used to refer to a number of URIs by means of which a group session is constructed.

At step 402 it is determined whether a session is possible, that is, whether it is possible to set-up a multimedia group session between the group session participants comprising the purchaser and the service suppliers. The possibility for the session depends on whether there are any service supplier parties available and whether or not the allowed number of purchaser parties assigned to the group session is exceeded. If the session is not yet possible, the method continues at step 402. The determination is performed either automatically by the purchaser mobile station or by the user herself based on information indicated to the user via the user interface of the mobile station.

If the session is possible, the method continues at step 404 where it is determined whether there arises a need for the purchaser to engage in the group multimedia session. In other words, the purchaser determines whether she has the need for the service purchased via the group session. If there is a need for the session, at step 406 the mobile terminal for the purchaser engages into a group multimedia session.

At step 406 the engaging into the group session may entail either establishing of the group session from the scratch or joining an existing group session between the service supplier parties. The establishing of the group session from the scratch comprises that an invitation is sent from the purchaser mobile station to an application server and the application server invites each service supplier party to the session. The joining of an existing group session comprises that from the purchaser mobile station is sent an invitation to the application server. The application server detects that the service suppliers already have an active group session. To the active group session may also belong at least one other purchaser mobile station or fixed station. The number of purchaser mobile stations connected to the group session may vary in time.

At step 408 a group multimedia session is ongoing between the group session participants. During the group session is sent a number of media spurts. During these media spurts video or voice data is presented to the session participants, especially the purchaser. At some point in time during the group session a service supplier party issues a payment request message for the purchasing user.

At step 410 the purchaser indicates acceptance to the application server in the form of an accept message.

At step 412, based on the payment request message data and the accept message data, the application server generates a transaction record and sends is towards the serving CSCF of the purchasing user. At step 414 the transaction record is sent from the serving CSCF towards a billing centre.

At step 416 a payment verification message is sent from the serving CSCF to the service supplier party, which originally issued the payment request message.

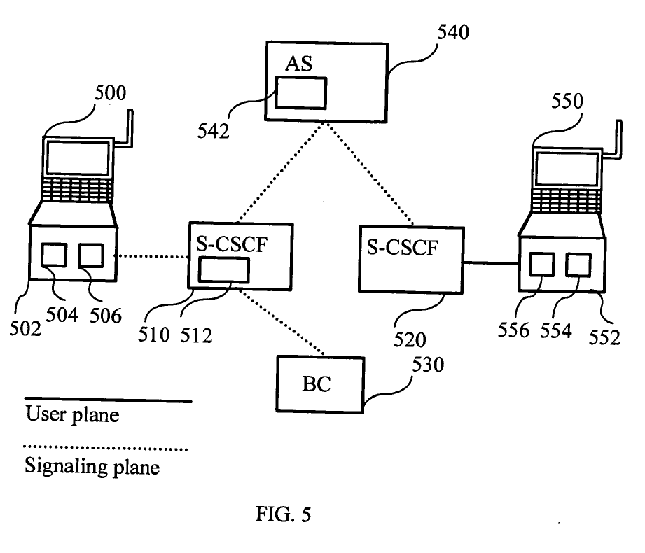

FIG. 5 illustrates a communication network in one embodiment of the invention. In FIG. 5 there is a purchasing mobile station 500. The internal functionalities and mobile station 500 are illustrated in FIG. 5 with box 502. There is a service purchase entity 504, which takes care of the sending of purchase accept messages and the receiving of payment request messages. There is also a communication entity 506 that takes care of all IP data packet related tasks. The IP packets may be associated with user plane or signalling plane. Signalling is illustrated in FIG. 5 using a dashed line and user plane traffic using a solid line. Communication entity 506 transmits and receives messages over the radio interface of mobile station 500 on behalf of service purchase entity 504. Communication entity 506 exchanges messages in internal format with service purchase entity 504. The communication entity 506 also performs the engaging of mobile station 500 in a group session and other session establishment, control and release related tasks. There is also a serving CSCF associated with the purchasing user 510. The serving CSCF 510 comprises a charging entity 512, which takes care of the receiving of payment request, accept and data messages and the forming of call detail records for a billing centre 530. There is also a serving CSCF associated with the service supplier 520. There is a service supplier mobile station 550. The internal functions of a mobile station 550 are illustrated with box 552. In mobile station 550 there is a communication entity 556 that takes care of all IP data packet traffic related tasks. The communication entity 556 also performs the joining of mobile station 550 in a group session and other session establishment, control and release related tasks. There is also a service supplier entity 554, which takes care of the sending a payment request message and receiving of a payment verification messages. Communication entity 556 transmits and receives messages on behalf of services supplier entity 554. Communication entity 556 exchanges messages in internal format with service supplier entity 554. Thus, service purchase entity 504 and service supplier entity 554 are communication peers and exchange payment related request and accept messages between one another via respective communication entities. Associated with the serving CSCF 510 there is the billing centre 530, which takes care of collecting of call detail records comprising payment information. There is also an application server 540 comprising a group session entity 542, which takes care of all Push-to-Talk over cellular multimedia session establishment, maintenance and release related functions. It also handles the relaying payment request messages, the receiving of payment accept messages, the sending of payment verification messages and the sending of payment data messages.

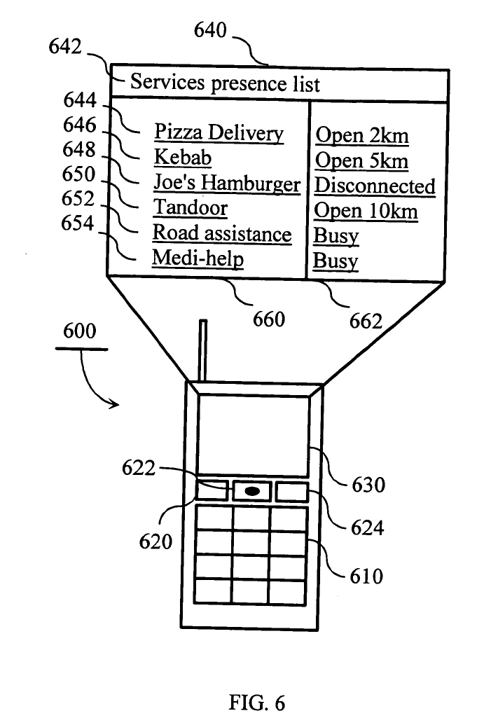

FIG. 6 is a block diagram illustrating a mobile station and the associated user interface in one embodiment of the invention. Mobile station 600 comprises a keyboard 610, two function keys, namely function keys 620 and 624, a pointer device 622 and a display 630. The contents of the display are illustrated in box 640. Box 640 illustrates the user interface for the payment method during step 402 in FIG. 4. During this phase it is waited until there arises a need for the purchaser to engage in a group multimedia session with the service suppliers referred to using a multiparty URI. The user interface comprises a header 642 and two columns 660 and 662. In column 660 there is listed a number of multiparty URIs. These URIs are associated with a number of service suppliers. These suppliers may belong to a single organizational entity or a number of different organizational entities such as competing companies. By a service supplier is simply meant in this context a group session party, which may send payment request messages to be accepted by the purchaser. In column 662 there is status information associated with each of these multiparty URIs. Column 662 comprises for each multiparty URI such information as whether there are any service supplier parties available for the multiparty URI, that is, whether any of the service supplier parties have registered as active for this multiparty URI. For example, if there is at least one pizza delivery service supplier, which has registered as available for a multiparty URI associated with pizza delivery, then on row 644, in the status column for pizza delivery, there is an indicator telling that the pizza delivery service is at the state open. If no service providers have register for a multiparty URI then in that case the multiparty URI line in the user interface will specify that this is multiparty URI is disconnected. In case there is another purchasing subscriber, which is currently connected to the group session associated with the multiparty URI, on the line associate with the multiparty URI there may be a busy indicator, which indicates that the multiparty URI may be considered busy. The busy state may be taken into consideration by the mobile station of the purchaser automatically or by the application server, in which case the user is not allowed to enter the group session. The other option is that the user herself decides not to engage into a group session, if it is indicated to be busy. In one embodiment of the invention the busy indicator is only displayed in case the number of purchasing users exceeds a given predefined limit. For example, if there are more than two or three purchasing users associated with that multiparty URI at that time. In one embodiment of the invention, there are also collected presence notifications providing information on, what the nearest service provider is, which has registered as active for the multiparty URI. So the distance to the nearest service provider is indicated also in column 662.

It is obvious to a person skilled in the art that with the advancement of technology, the basic idea of the invention may be implemented in various ways. The invention and its embodiments are thus not limited to the examples described above; instead they may vary within the scope of the claims.

1. A method for payment in association with a group session in a communication system comprising at least a mobile station, a session control node and an application server, the method comprising:
selecting a group session identifier in said mobile station;
sending a session set-up request comprising said group session identifier from said mobile station to said application server;
engaging in said application server said mobile station in a group session associated with said group session identifier, said group session further comprising at least a communication device;
sending a payment request message from said communication device to said mobile station;
accepting said payment request message in said mobile station;
sending a payment accept message from said mobile station to said communication device via said session control node and said application server; and
submitting a charging record from said session control node to a billing center, said charging record comprising information from said payment accept message.

2. The method according to claim 1, the method further comprising:
said mobile station subscribing to event notifications associated with said group session identifier;
said mobile station receiving at least one notification associated with said group session identifier;
said mobile station updating a status of said group session identifier based on said at least one notification;
said mobile station checking said status in response to detecting a session set-up command associated with said group session identifier from the user; and
said mobile station accepting or rejecting said session set-up command based on said status.

3. The method according to claim 1, the method further comprising:
checking the validity of said payment accept message in said application server, said validity comprising at least an existence of said group session between said mobile station and said communication device;
submitting a payment data message from said application server to said session control node;
generating said charging record in said session control node based on information in said payment data message.

4. The method according to claim 1, the method further comprising:
forming a digital signature for said payment accept message in said mobile station using a secret key associated with said mobile station; and
checking said digital signature in said billing center.

5. The method according to claim 1, wherein said mobile station is a General Packet Radio System terminal or a Universal Mobile Telecommunications System terminal.

6. The method according to claim 1, wherein said mobile station is a Wireless Local Area Network (WLAN) mobile station.

7. The method according to claim 1, wherein said group session comprises a Push-to-Talk over Cellular (PoC) group session and said application server comprises a Push-to-Talk over Cellular (PoC) server.

8. The method according to claim 1, wherein said session control node comprises a Call State Control Function (CSCF).

9. The method according to claim 1, wherein said payment request messages and said payment accept messages comprise Session Initiation Protocol (SIP) messages.

10. The method according to claim 1, wherein said group session comprises an IP multimedia session.

11. A communication system comprising at least a mobile station, a session control node and an application server, the system further comprising:
a communication entity in said mobile station configured to select a group session identifier in said mobile station and , to send a session set-up request comprising said group session identifier from said mobile station to said application server;
a group session entity in said application server configured to engage said mobile station in a group session associated with said group session identifier, said group session further comprising at least a communication device;
a service supplier entity in said communication device configured to send a payment request message to said mobile station;
a service purchase entity in said mobile station configured to accept said payment request message in said mobile station, and to send a payment accept message to said communication device via said session control node and said application server; and
a charging entity in said session control node configured to submit a charging record to a billing center, said charging record comprising information from said payment accept message.

12. The communication system according to claim 11, the system further comprising:
a communication entity in said mobile station configured to subscribe to event notifications associated with said group session identifier, to receive at least one notification associated with said group session identifier, to update a status of said group session identifier based on said at least one notification, to check said status in response to detecting a session set-up command associated with said group session identifier from the user, and to accept or reject said session set-up command based on said status.

13. The communication system according to claim 11, the system further comprising:
a group session entity in said application server configured to check validity of said payment accept message, said validity comprising at least an existence of said group session between said mobile station and said communication device, to submit a payment data message to said session control node; and
a charging entity in said session control node configured to generate said charging record based on information in said payment data message.

14. The communication system according to claim 11, the system further comprising:
a service purchase entity in said mobile station configured to form a digital signature for said payment accept message with a secret key associated with said mobile station; and
said billing center configured to check said digital signature.

15. The communication system according to claim 11, wherein said mobile station is a General Packet Radio System terminal or a Universal Mobile Telecommunications System terminal.

16. The communication system according to claim 11, wherein said mobile station is a Wireless Local Area Network (WLAN) mobile station.

17. The communication system according to claim 11, wherein said group session comprises a Push-to-Talk over Cellular (PoC) group session and said application server comprises a Push-to-Talk over Cellular (PoC) server.

18. The communication system according to claim 11, wherein said session control node comprises a Call State Control Function (CSCF).

19. The communication system according to claim 11, wherein said payment request messages and said payment accept messages comprise Session Initiation Protocol (SIP) messages.

20. The communication system according to claim 11, wherein said group session comprises an IP multimedia session.

21. An electronic device comprising:
a communication entity configured to select a group session identifier, and to send a session set-up request comprising said group session identifier to an application server; and
a service purchase entity configured to accept a payment request message, to send a payment accept message to a communication device via a session control node and said application server.

22. An application server comprising:
a group session entity configured to receive a session set-up request comprising a group session identifier from a mobile station, to engage said mobile station in a group session associated with said group session identifier, said group session further comprising at least a communication device, to relay a payment request message and a payment accept message between said mobile station and said communication device, to check validity of said payment accept message, said validity comprising at least an existence of said group session between said mobile station and said communication device, and to submit a payment data message comprising information from said payment accept message to a session control node.

23. A computer program comprising code adapted to perform the following steps when executed on a data-processing system:
receiving a session set-up request comprising a group session identifier from a mobile station;
engaging said mobile station in a group session associated with said group session identifier, said group session further comprising at least a communication device;
receiving a payment request message from said communication device;
sending said payment request message to said mobile station;
receiving a payment accept message from said mobile station;
informing said communication device of said payment accept message; and
submitting a payment data message comprising information from said payment accept message to a session control node.

24. The computer program according to claim 23, wherein said computer program is stored on a computer readable medium.

25. The computer program according to claim 24, wherein said computer readable medium is a removable memory card.

26. The computer program according to claim 24, wherein said computer readable medium is a magnetic or an optical disk.
